(19) United States
(12) Patent Application Publication
(10) Pub. No.: US 2011/0196991 A1
(43) Pub. Date: Aug. 11, 2011

(54) NETWORK CONNECTABLE COMPUTING DEVICE PROVIDING POWER OUTLET AND DATA CONNECTIONS

(75) Inventor: Tareq A. Samaha, Roseville, CA (US)

(73) Assignee: TECHSTONE SOFT, INC., Roseville, CA (US)

(21) Appl. No.: 13/025,628

(22) Filed: Feb. 11, 2011

Related U.S. Application Data
(60) Provisional application No. 61/303,450, filed on Feb. 11, 2010.

(51) Int. Cl. G06F 3/00

(52) U.S. Cl. 710/12

(57) ABSTRACT

Described herein is a network connectable device which may draw power from a network connection and distribute data and power to peripheral devices connected to the device. This obviates the need for the device and the connected peripheral devices to have their own additional power sources. The device and the peripheral devices are not restricted from using additional power sources. The device provides an all IP (Internet Protocol) solution equivalent to USB Peer-to-Peer connectivity. Video, HD (High Definition), 3D, full control USB and/or serial connections are enabled to and from devices such as keyboards, joysticks or monitors, with connectivity from anywhere on the network.

### CROSS-REFERENCE TO RELATED APPLICATION

This application claims priority from U.S. Provisional Patent Application Ser. No. 61/303,450, entitled “Network Connectable Computing Device Providing Power Outlet and Data Communications,” filed Feb. 11, 2010, which is hereby incorporated by reference in its entirety.

### TECHNICAL FIELD

This invention relates to the field of network connectable computing devices.

### BACKGROUND

Non-provisional application Ser. No. 12/587,921, filed Oct. 14, 2009 is hereby incorporated by reference in its entirety.

Networks and network standards provide interconnection for computing devices. Buses and bus standards provide interconnection for computing devices and peripherals. Generally, each of the computing devices, whether standalone or connected to a network, has its own power source, which can be a power cord to a power outlet or batteries. Peripherals may have their own power supply or draw power from a bus connection. Network connections may or may not be conveniently located near a power source such as a wall outlet or batteries.

USB (Universal Serial Bus) is a standard for connection between computing devices and peripherals. USB provides a data connection over which the computing device and the peripheral communicate, and USB provides power to charge and power a peripheral. However, USB is not well-suited for tables of more than 5 meters length, while network cables may be longer. USB over IP (Internet Protocol) allows connection of USB devices to the Internet, but does not provide power to the USB device.

An Ethernet connection can provide power to Ethernet devices. Applicable standards are PoE (Power over Ethernet) and the emerging PoE-Plus, which can provide up to 30 W and up to 60 W of power, respectively over CAT 5 or CAT 6 cable.

### SUMMARY

It is an object of the present invention to provide a network connectable device which can draw power from the network connection and provide power and rich data, control, mobility and sharing connections to computing or multimedia devices and peripherals such that neither the network connectable device nor any of the computing devices or peripherals require their own additional power source. Nonetheless, a computing device or peripheral with an additional power source could be connected to the network as well.

It is a further object of the present invention to provide an all IP (Internet Protocol) solution equivalent to USB Peer-to-Peer connectivity, with the advantages of elimination of USB Peer-to-Peer and allowing connection from anywhere on the network. Video, HD (High Definition), 3D, full control USB and/or serial connections are enabled to and from devices such as keyboards, joysticks or monitors, with connectivity from anywhere on the network.

It is a still further object of the present invention to provide a network connectable device acting as an Always-On and Always-Connected device with high availability, control and support to larger systems.

It is a yet further object of the present invention to simplify the installation of system solutions, and to provide a single cable solution with improved security, safety and usability.

### BRIEF DESCRIPTION OF THE DRAWINGS

FIG. 1 is an exemplary diagram showing the various devices.

FIG. 2 is an exemplary diagram primarily showing a network connectable device providing power output and data connection.

### DETAILED DESCRIPTION

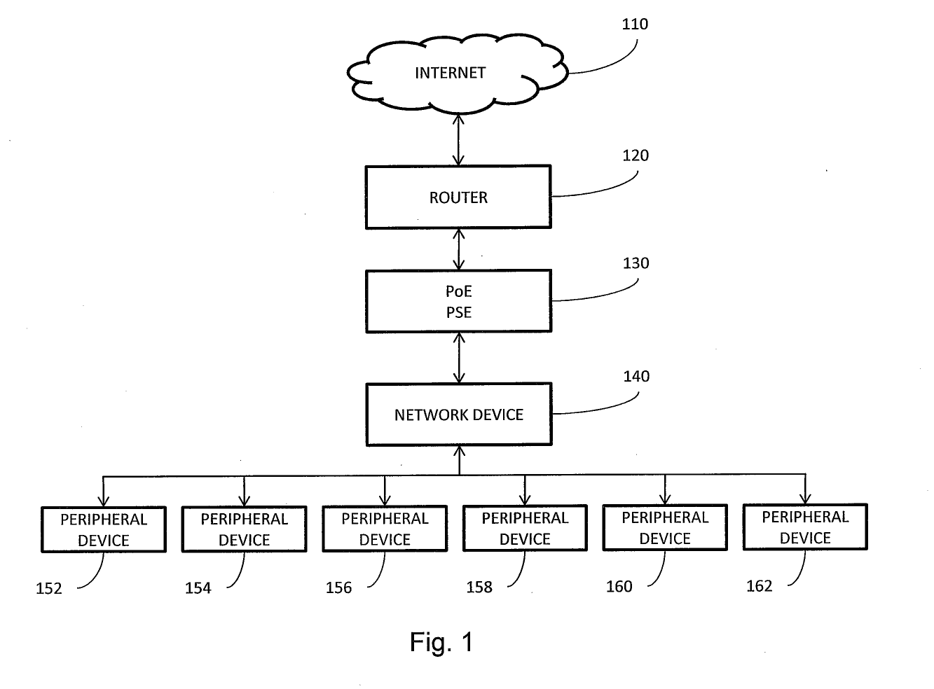

The various devices and their ultimate connection to the Internet 110 are shown in FIG. 1. Peripheral devices 152 through 162 are shown connected to a network connectable device 140 which may provide power output and data connections to peripheral devices 152 through 162. The network connectible device 140 is connected to a power over Ethernet power supply 130 which provides power and data to the network connectible device 140. The power over Ethernet power supply 130 is a managed and software programmable power supply which is connected to router 120 thereby establishing and providing interconnection with a local area network (not shown). The power over Ethernet power supply 130 may be replaced with a power supply equivalent to a PoE or PoE+ power supply. Access to the Internet 110 is provided by the router 120 by any of the various methods known in the art.

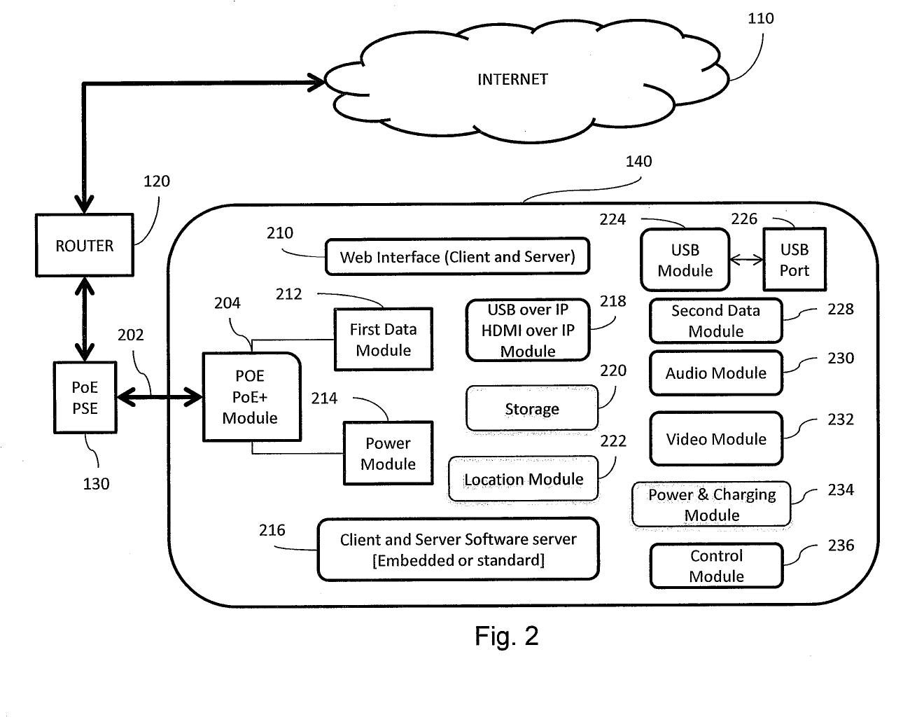

With reference to FIG. 2, the network connectable device 140 providing power output and data connections is shown. The device 140 connects to the local area network established by router 120 and the global communication network 110 known as the Internet via an Ethernet connection 202. The Ethernet connection 202 essentially provides a network port, at least one PoE or PoE+ Port, by connection to the router 120 through the power over Ethernet power supply 130. The connection to the Internet 110 is provided by the router 120. The device 140 separates power from the Ethernet connection 202, provides data connections to external peripherals 152 through 162 of FIG. 1, and provides power from the Ethernet connection 202 to its own modules and circuits as well as to external devices. For ease of viewing, the physical connections between the modules of the network connectable device 140 are not shown. These connections are well known in the art.

The network connectable device 140 may be comprised of multiple modules. A Web Interface 210 also connects to the Internet 110 via the Ethernet connection 202. Physical standards for the connector and protocol standards for the signaling and data are adhered to.

A PoE or PoE+ Module 204 extracts power from the Ethernet connection 202 and separates the power from the data, providing power and data to other modules or to external connections.

A first Data Module 212 routes data to and from other modules within the device. The first Data Module 212 connects to the Web Interface 210 and to the PoE or PoE+ Module 204 as well as other modules. The first Data Module 212 moves data to or from the Web Interface 210 and thereby to or from the Internet 110, and moves data to or from other modules by means of one or more data buses (not shown).

A Power Module 214 routes electrical power to other modules within the device through various connections (not shown). The Power Module 214 gets power from the PoE or PoE+ Module 204, and thereby from the Ethernet connection 202. The Power Module 214 may step voltage up or down, condition power and distribute differing levels of voltage or current to internal modules. The power module 214 is a high-efficiency power module.

A USB Module 224 connects to a USB port 226 which provides a USB connection to external peripherals. The USB port 226 provides power to USB peripherals, per the USB standard. The power provided by the USB port 226 is obtained from the Power Module 214 and is thus from the Ethernet connection 202.

A second Data Module 228 connects to a port (not shown) which provides a data connection to external peripherals.

An Audio Module 230 connects to a port (not shown) which provides an audio connection to external peripherals such as speakers.

A Video Module 232 connects to a video port (not shown) which provides a video connection to external peripherals such as displays. The Video Module 232 may conform to HD (High Definition), 2D or 3D (two dimensional or three dimensional) video standards.

A Power and Charging Module 234 connects to one or more power outlets (not shown) and provides DC and/or AC power to external devices. The Power and Charging Module 234 obtains power from the Power Module 214 and thus obtains power from the Ethernet connection 202.

A Control Module 236 provides interactive control, such as from user operated I/O devices (not shown). The Control Module 236 may support one or more ports (not shown) for user operated devices such as a mouse, a joystick, a trackball, a touch pad, buttons etc., or the Control Module may support I/O devices connected to the USB port 226 or another port as part of another module. The Control Module 236 may be connected to any of the modules which support user I/O.

A Server 216, which may be embedded or standard, and which may operate client and/or server software, provides server functions for the modules, devices and storage 220 of the network connectable device and may interact with other devices, servers, memories or services on the global communication network 110 known as the Internet via the Ethernet connection 202.

Further, the Server 216 may perform functions associated with or in support of the system or method disclosed in the cross-referenced application.

A Location Module 222 provides a location service and may have a GPS (Global Positioning Satellite) interface, an electronic compass or an accelerometer (not shown) for location, orientation and other positioning information.

A USB over IP and HDMI (High-Definition MultiMedia Interface) over IP Module 218 handles formatting and associated standards for communicating with a USB peripheral over an Ethernet connection and communicating with an HDMI peripheral such as a video monitor over an Ethernet connection, respectively. This Module 218 connects to the USB Module 224 and the Video Module 232.

Any module in the network connectable device 140 that is communicating data, to or from the Internet 110, may connect to the Internet 110 or the local area network established by router 120 directly through the First Data Module 212, or through some other module in the network connectable device 140. The other module may be 3G/4G, BT, ZigBee, Wi-Fi, or any direct (peer-peer) or infrastructure mode, or both. As an example, the USB over IP, HDMI over IP module 218, may communicate in two directions. Module 218 may use WIFI for communication to the Internet 110 or local area network established by router 120 or use Ethernet through the first data module 212 and the Ethernet connection 202 or both at the same time. The same can happen if the connectivity is 4G (LTE, Wi-Max, etc.). In an alternate embodiment the Ethernet connection 202 may be connected to the router 120 on the local area network established by router 120, while the web interface 210 is communicating through 4G or a Wireless Network. Once these signals are on the local area network similar hardware or software modules in the network connectable device 140 leverage and consume the USB over IP, HDMI over IP, and other signals. Variations of these and other connections may be devised by a person skilled in the art.

The network connectable device 140 allows multiple computing and peripheral devices to share an Internet connection without the need for separate power supply. For example, applications in automotive, home networks, classrooms, medical applications, entertainment, security, digital signage, point of sale and connected displays may use the network connectable device. Shared computing, gaming, educational or business environments may be enabled by the network connectable device. Interactive advertisement can be enabled as well.

Warehouse, retail store, manufacturing and other business operations environments may benefit. A computing device, a phone, a camera, a peripheral, appliances and a connected display can be connected to each other and the Internet and powered by the Internet connection at the same time. A device with a chargeable battery can be charged while in full operation.

The network connectable device 140 further allows controlling other devices with high-powered requirements. For example, a high-power industrial machine or high-powered consumer machine can provide a managed connectivity and managed power to control the large power supply on the device, and also allow management using software and standard web development tools, applications and solutions.

What is claimed is:

1. A network connectable device comprising:
a network module providing an internal network connection and a network port connectable to a network;
a power and data separation module that extracts electrical power from the network port, provides power to a power outlet and an internal power routing, and provides an internal data connection from the internal network connection; and
a USB module having a USB port that provides power available to an external USB peripheral from the internal power routing and that provides a USB data connection available to the external USB peripheral from the internal data connection.

2. The device of claim 1 further comprising an audio module.

3. The device of claim 1 further comprising a video module.

4. The device of claim 1 further comprising a memory storage.

5. The device of claim 1 further comprising a server.

6. The device of claim 1 further comprising embedded software.

7. The device of claim 1 further comprising a data module.

8. The device of claim 1 further comprising a location module.

9. The device of claim 1 further comprising a control module.

10. The device of claim 1 wherein the device is included in a system.

11. The device of claim 4 further including software and drivers installed in a portion of the memory storage.

12. The device of claim 1 wherein the network module communicates using Secure Peer-to-Peer communication.

13. The device of claim 1 further including a high-efficiency power module.

14. The device of claim 1 further including a managed and software programmable power supply.

15. The device of claim 1 wherein the USB module supports plug and play over IP.

16. The device of claim 1 wherein power is supplied using a standard connector.

17. The device of claim 1 further comprising at least one PoE or PoE+ Port.

18. The device of claim 1 wherein power is supplied using a power supply equivalent to a PoE or PoE+ power supply, and the device can pass data alone or power alone.

19. The device of claim 1 wherein the device will work in an IP environment, IPv6, IPv4 or Peer-to-Peer.

20. The device of claim 1 wherein the device connects to a power supply of an automobile and provides power to the USB port, the power outlet and the internal power routing of the device from the power supply of the automobile.

21. The device of claim 1 wherein the device conforms to IP standards and USB over IP standards.

22. The device of claim 1 wherein the device conforms to Link Layer Discovery Protocol (LLDP) in an association of devices with users and host machines.
